(19) United States
(12) Patent Application Publication
(10) Pub. No.: US 2005/0196505 A1
(43) Pub. Date: Sep. 8, 2005

(54) Extruded cookie units having interior designs

(75) Inventors: Susan M. Hayes-Jacobson, Minneapolis, MN (US); Julie A. Piasecki, Coon Rapids, MN (US); Glenn O. Rasmussen, Champlin, MN (US); Cara J. Sekerak, Lakeville, MN (US); Julia M. Schmelzer, St. Louis Park, MN (US); Lanette M. Shaffer, Hudson, WI (US)

Correspondence Address: Arlene Hornilla;General Mills, Number One General Mills Blvd., P.O. Box 1113, Minneapolis, MN, 55440, US

(73) Assignee: The Pillsbury Company

(21) Appl. No.: 11/074,189

(22) Filed: Mar. 7, 2005

Related U.S. Application Data
(63) Continuation-in-part of application No. 10/267,472, filed on Oct. 9, 2002, now abandoned.
Application No. 10/267,472 is a continuation-in-part of application No. 10/267,539, filed on Oct. 9, 2002.

(51) Int. Cl. A21D 10/00

(52) U.S. Cl. 426/549

(57) ABSTRACT

Ready-to-bake cookie units that are coextruded include ornamental designs through a thickness of the cookie unit. The ornamental designs can be produced in a variety of configurations using a plurality of visually distinct, coextrudable cookie doughs. Dough formulations advantageous for use in the coextrusion of the ready-to-bake cookie units are also provided.

### CROSS-REFERENCES TO RELATED APPLICATIONS

The present application is a continuation-in-part application of and claims priority to U.S. patent applications Ser. No. 10/267,472 filed Oct. 9, 2002, entitled, “Shaped Cookie Intermediates Having Interior Designs,” and Ser. No. 10/267,539 filed Oct. 9, 2002, entitled, “Packaged Cookie Intermediates With Integral Designs,” both of which are herein incorporated by reference to the extent not inconsistent with the present disclosure.

### FIELD OF THE INVENTION

The invention relates to refrigerated, pre-portioned cookie dough units and more particularly to cookie dough units provided in an easy to use and convenient format for baking by a consumer.

### BACKGROUND OF THE INVENTION

There are presently a wide variety of refrigerated, ready-to-bake cookie units commercially available. One example of refrigerated, ready-to-bake cookie units are the sheets of scored, grooved or perforated blocks of cookie dough such as those illustrated in U.S. Pat. Nos. 6,280,783, 6,284,295 and 6,312,743, which have been brought to market by the Nestle Corporation of Vevey, Switzerland. Generally, the scored dough sheet is provided in a package that may consist of a plate and outer wrapping. In use, the consumer removes the sheet of dough from the package and breaks off individual squares or pieces. The pieces or squares are then placed on a cookie sheet or other baking vessel and upon the application of heat the cookies are baked. During baking, the pieces or squares expand to form a generally circular baked cookie. While the foregoing product provides a level of convenience, there are a number of drawbacks associated with this particular product. The scored dough sheet requires the consumer to individually separate the cookie units prior to placement on the cookie sheet. If the scoring is irregular or of insufficient depth, separation can result in the formation of irregular pieces, both in size and shape, such that the resulting baked cookies can differ in size, shape or appearance from other baked cookies within the same batch. The separation of the cookie pieces can also cause crumbling of the product during separation such that a consumer can encounter additional clean-up time. Finally, the separation process generally requires the consumer to touch or grasp the cookie sheet during separation of the cookie units such that consumer must subsequently clean and dry their hands, which if in a hurry can be an additional distraction to the consumer.

U.S. Pat. No. 3,228,356 discloses the use of three separate pastry streams to produce a cookie having a design appearing on one surface or on the face of the cookie. The design comes out ahead of a cookie base, providing a single sided design or a laminated arrangement or appearance. If the cookie is flipped over, one only sees the backside of the cookie, minimizing the value of applying a design to the cookie. Such laminated cookies can also appear to have a “fabricated” look to them, in that each layer of the cookies is visible rather than a homogenous structure or configuration, in which the design element is integrated into the cookie itself.

Another example of a refrigerated ready-to-bake cookie dough products is shown in U.S. Pat. No. 5,171,599 (commonly assigned) in which edible bits, such as candy pieces, are embedded in the cookie dough to define a visible decoration. Again, the dough is removed from its packaging and baked. The decorations, while adding a pleasing aesthetic appearance to the cookie are visible only on one side of the cookie such that a consumer does not see the decoration should the cookie become inverted.

U.S. Pat. No. 5,620,713 (commonly assigned) discloses an extrusion die and extrusion methods for forming ready-to-bake cookie units having a visible, internal design. Generally, the internal design is created through the use of at least two visually distinct cookie doughs that are simultaneously extruded through a die to form a dough log that is then packaged in a tube. In use, the consumer unwraps the log and slices the log into individual cookie dough units. While this product offers convenience, the user has to unwrap the dough log from the package and then the unused portion of the log must be re-wrapped to protect from spoiling. In addition, the user has to slice off individual cookies from the log, which can lead to odd shaped cookies or cookies of different thicknesses. If some cookie units are sliced too thin, the resulting baked cookies may be overdone while cookie units that are sliced too thick, may be underdone. Furthermore, slicing individual cookies from a dough log can require additional handling and clean-up by the consumer.

In addition to the previously described and referenced ready-to-bake cookies, there are many varieties of decorated cookies, which can be found at bakeries, retail food outlets and the like. These cookies are typically created from a single type of dough and then cookie cutters, having the particular desired configuration of the final shape, are then pressed into a sheet of the dough to produce a cookie having that shape. Any excess dough surrounding the cutter is then stripped away and the shaped cookie unit is then baked. These cookies can have decorative elements added to them such as frosting, candy sprinkles, food coloring and the like. Decorative cookies made in this fashion suffer from a number of drawbacks, in that they are generally made individually or in very small batches and can be very time consuming, consequently making them expensive to produce. Furthermore, the decorative elements are generally visible on only one side of the cookie. As such, if the cookie becomes inverted the decoration is no longer visible to the consumer and would likely result in the decorative element losing its design integrity.

In a commercial environment, a ready-to-bake dough unit having a design on one side or surface of the unit can become inverted due to various conveying and packaging operations. For example, cookie units can be inverted during conveyor or packaging transfers, such that if a decorative element is on only one side of the cookie unit, the resulting cookie package may require rejection. Correction of this situation requires manual intervention to fix the problem, thus incurring additional costs.

Another problem with such prior art cookies can occur when a design element or decoration is created through the placement of candy sprinkles or frosting on one side of the cookie unit, which can subsequently fall off the cookie during packaging, shipping or display. This can either destroy or distort the initial design being offered by the manufacturer or baker. This again diminishes the value of the offering in the eyes of the consumer.

In other situations, food coloring can be used to visually distinguish and decorate a cookie unit. However, the use of food coloring can causing color bleed into unintended areas making the design difficult to recognize. In addition, if the ready-to-bake cookie units or bake cookies with the dye or coloring are handled shortly after the coloring has been applied, the food coloring can come off on packaging or transfer to other cookies within the package.

As such, it would be advantageous to have a ready-to-bake cookie unit that avoided the disadvantages of the prior art. Furthermore, it would be advantageous to have a ready-to-bake cookie unit that was amenable to typical production rates while avoiding the disadvantages of the prior art.

### BRIEF SUMMARY OF THE INVENTION

The embodiments of the invention described below are not intended to be exhaustive or to limit the invention to the precise forms disclosed in the following detailed description. Rather, the embodiments are chosen and described so that others skilled in the art may appreciate and understand the principles and practices of the invention.

In a representative embodiment, a ready-to-bake cookie unit can be extruded such that an ornamental design is displayed throughout a thickness of the cookie unit such that the ornamental design is viewable on both a top and bottom surface of the cookie unit. The ready-to-bake cookie unit can be formed of at least two cookie doughs wherein the cookie doughs comprise substantially the same dough formulation with the only significant difference pertaining to the color of the individual cookie doughs. A first cookie dough defines an exterior perimeter of the cookie unit while the second cookie dough defines the ornamental design, within the bounds of the first dough. The first cookie dough can comprise from about 40% to about 90% of the cookie unit or can comprise from about 50% to about 80% of the cookie unit. In an alternative embodiment, the cookie unit can comprise at least one additional dough differing in color from the first and second doughs such that the additional dough provides an accent color to the ornamental design. The additional cookie dough can comprise from about 2% to about 60% of the cookie unit or can comprise from about 5%-50% of the cookie unit. Depending on the number of additional doughs in the cookie unit, these percentages can be modified accordingly.

In another representative embodiment, an extrudable cookie dough can be formulated so as to be extrudable at typical production rates while also offering acceptable expansion properties during subsequent baking. The extrudable cookie dough can comprise a desired shortening such that the dough is neither too sticky to pump or too deformable to form a structurally sound cookie unit. The extrudable cookie dough can comprise a specifically sifted sugar having a particle size distribution within advantageous ranges for both extrusion and baking. The extrudable cookie dough can further comprise desired ratios of ingredients, for example sugar to flour, that have been found to be especially preferred by consumers, such as, for example due to the taste or appearance of a baked cookie.

In other representative embodiment, methods for preparing an extrudable cookie dough having both desirable processing and baking traits is disclosed. The extrudable cookie dough can be formulated so as to be suitable for pumping and extrusion while having acceptable expansion characteristics during baking. Through selection of desirable ingredients such as, for example, shortening and sugar, the extrudable cookie dough can be used to form ready-to-bake cookie units having acceptable structural properties for manufacturing and shipment while providing baked cookies that are acceptable to consumers. Additionally, the extrudable cookie dough can be formulated having desired ingredient ratios such as, for example, sugar to flour ratios, that have been found to be especially desirable to consumers such as, for example, based on taste or appearance.

Representative embodiments of the cookie dough units can be extruded in various configurations so as to include any sort of internally, preformed design element. More specifically, the invention is directed to the substantially simultaneous extrusion of at least two visually distinct cookie doughs to form individual cookie dough units, which include an interior design or illustrative of a particular theme or event, such as holiday, special occasion, sporting event and the like.

The above summary of the various representative embodiments of the invention is not intended to describe each illustrated embodiment or every implementation of the invention. The figures in the detailed description that follow more particularly exemplify these embodiments.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 is a front view of a cookie dough unit that has been prepared according to an embodiment of the invention;

FIG. 1A is a cross-sectional view of the cookie dough unit of FIG. 1;

FIG. 2 is a front view of a further cookie dough unit prepared in accordance with another embodiment of the invention;

FIG. 3 is a front view of a further cookie dough unit prepared in accordance with a further embodiment of the invention; and

FIG. 4 is a flow diagram illustrating the steps in manufacturing the cookie dough units in accordance with an embodiment of the invention.

### DETAILED DESCRIPTION OF THE PREFERRED EMBODIMENTS

As used herein the term “dough unit,” “cookie dough unit” or “individual cookie dough unit,” which may at times herein be used interchangeably, refers to an article that is produced or manufactured which is in a non-baked condition and requires some further thermal processing such as baking, cooking or frying to change the intermediate into a condition that is suitable for consumption.

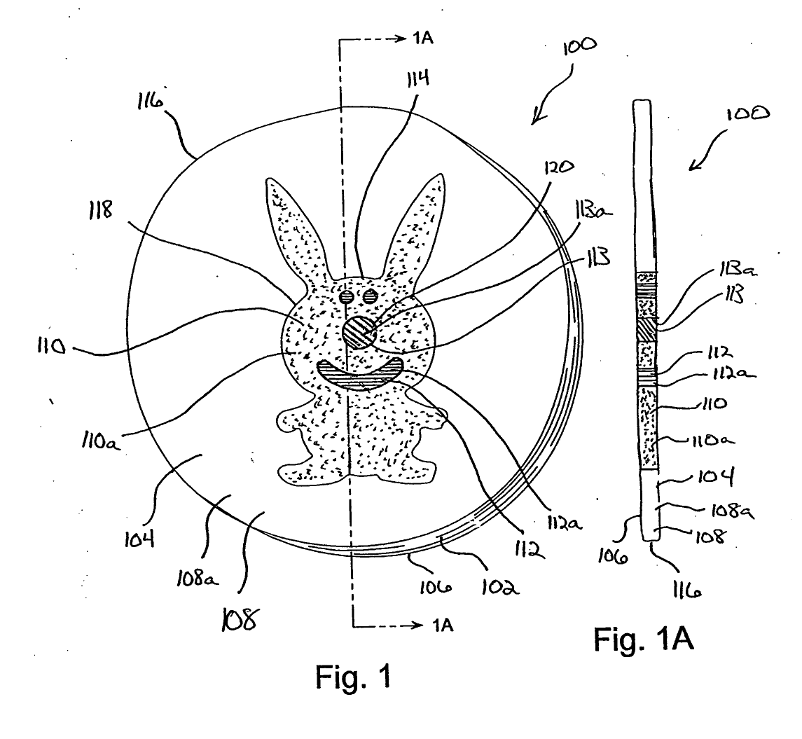

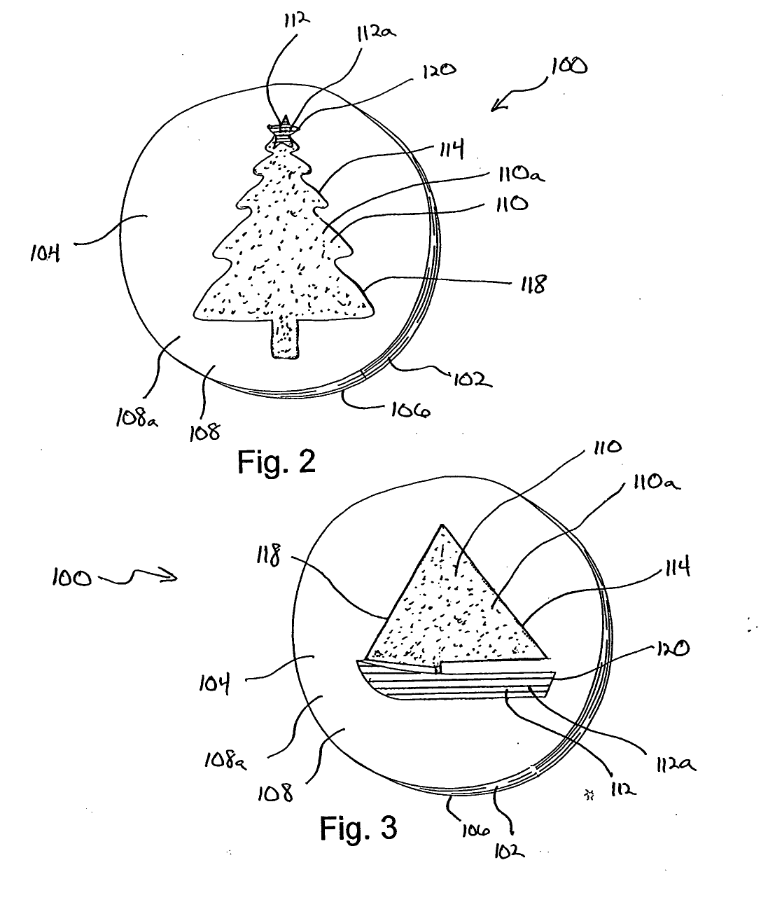

Turning now to FIGS. 1 and 1A, a cookie dough unit 100 has a generally, cylindrical external configuration 102. In alternative configurations, cookie dough unit 100 can comprise other suitable geometric configurations such as, for example, square, triangular, rectangular, hexagonal, pentagonal, and the like. The cookie dough unit 100 is provided with a first side 104 and a second side 106 as illustrated in FIG. 1A. Cookie dough unit 100 comprises at least a first dough portion 108 and a second dough portion 110. First dough portion 108 has a first color 108a while second dough portion has a second color 110a, wherein first color 108a and second color 110a are visually distinct. Cookie dough unit 100 can additionally comprise additional cookie doughs, such as, but not limited to, a third cookie dough 112 having a third color 112a as illustrated in FIGS. 1 and 1A, and possibly even a fourth cookie dough 113 having a fourth color 113a.

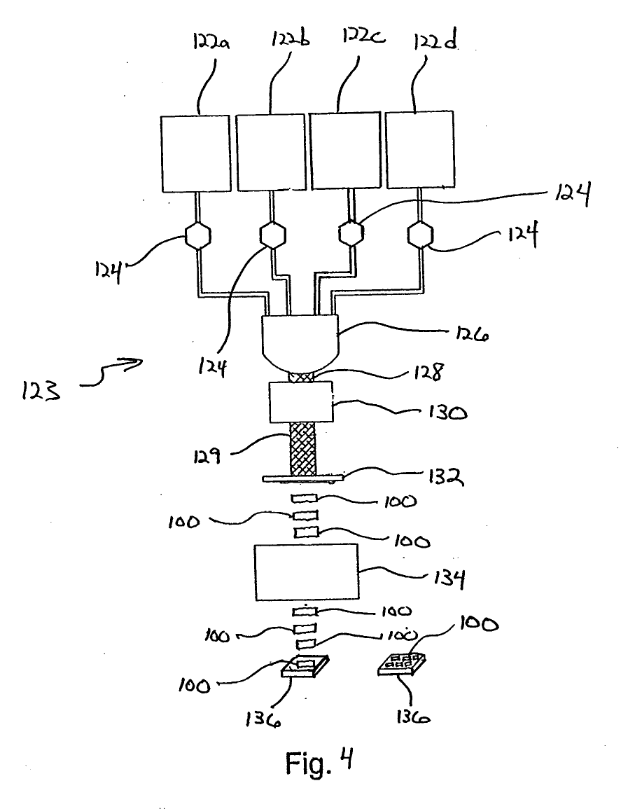

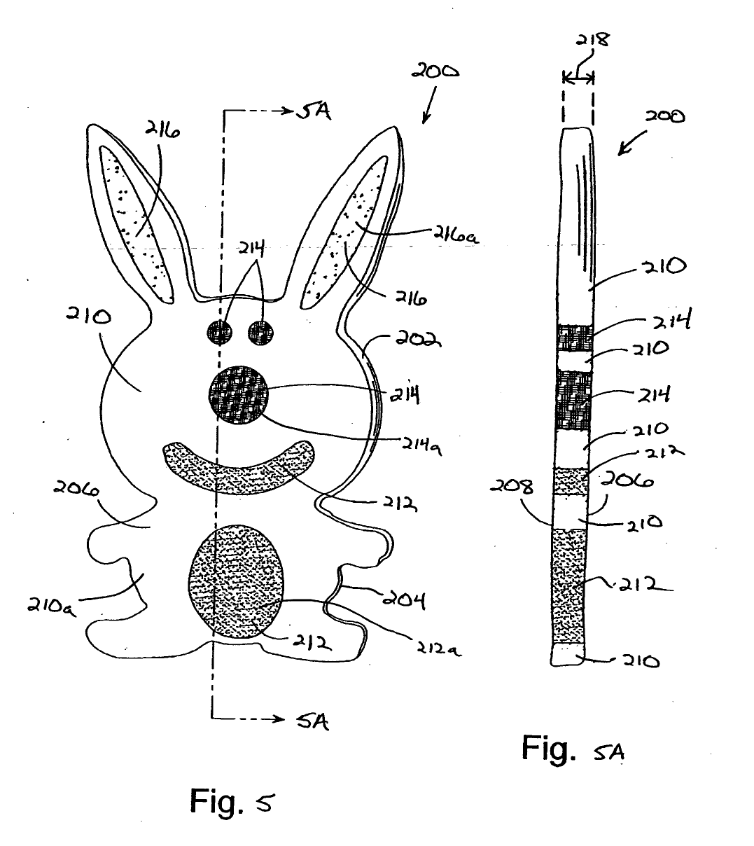

As shown in FIGS. 1 and 1A, cookie dough unit 100 comprises an ornamental design 114 extending throughout a unit thickness 116 of the cookie dough unit 100. As such, ornamental design 114 is viewable and recognizable regardless of which side, first surface or side 104 or second surface or side 106, is upwardly facing and viewable. As illustrated in FIG. 1, ornamental design 114 can comprise a holiday symbol, such as, for example an Easter bunny. Alternatively, ornamental design 114 can comprise a Christmas tree as depicted in FIG. 2 or a sailboat as depicted in FIG. 3. Ornamental design 114 can comprise other suitable symbols, logos, pictures or text such as, for example, designs representing holiday themes, seasonal themes, athletic themes, corporate themes, religious themes, patriotic themes, educational themes, occupational themes, geographical themes and the like.

First dough portion 108 defines an external perimeter 116 as well as an internal boundary 118 bounding the ornamental design 114. First dough portion 108 is typically representative of a background portion of the cookie dough unit 100. First dough portion 108 can comprise from about 40% to about 90% of the cross-sectional area of cookie dough unit 100 or can comprise from about 50% to about 80% of the cookie unit. The amount of first dough portion 108 in a specific embodiment of cookie dough unit 100 can vary based upon the size and shape of ornamental design 114 as well as the size and shape of external configuration 102.

Second dough portion 110 generally defines the shape and appearance of ornamental design 114. Ornamental design 114 may be wholly confined within the first dough portion 108 or may extend to or even beyond the external perimeter 116 or be coterminous with the external perimeter 116 of the cookie dough unit 100. Second dough portion 110 can comprise from about 2% to about 60% of the cross-sectional area of cookie dough unit 100. The amount of second dough portion 110 in a specific embodiment of cookie dough unit 100 can vary based upon the size and shape of ornamental design 114 as well as the size and shape of external configuration 102. Thus in certain embodiments, a second dough portion can comprise from about 5% to about 50% of the cookie unit. Depending on the number of additional doughs in the cookie unit, these percentages can be modified accordingly.

For example, as shown in FIGS. 1 and 2, Third dough portion 112 and fourth dough portion 133 (not shown) can generally define an accent component 120 within the cookie dough unit 100. Accent component 120 generally helps to further define and distinguish the ornamental design 114. Accent component 120 may be in contact with the second dough portion 110 as illustrated in FIG. 1. Alternatively, accent component 120 can be in contact with both the first dough portion 108 and the second dough portion 110 as illustrated in FIG. 3. Accent component 120 may be wholly confined within either the first dough portion 108 or second dough portion 110 or may extend to or even beyond the external perimeter 116 or be coterminous with the external perimeter 116 of the cookie dough unit 100. Together, third dough portion 112 and fourth dough portion 113 can comprise from about 2% to about 30% of the cross-sectional area of cookie dough unit 100. The amounts of third dough portion 112 and fourth dough portion 113 in a specific embodiment of cookie dough unit 100 can vary based upon the size and shape of ornamental design 114, the size and shape of accent component 120 and the size and shape of external configuration 102.

First dough portion 108, second dough portion 110, third dough portion 112 and fourth dough portion 113 generally comprise substantially the same dough formulation, with the possible exception of slight moisture variations, and possessing distinct and different colors such as, for example, first color 108a being white or cream-like, second color 110a being green-like, third color 112a being red-like and fourth color 113a being blue-like. Generally, first color 108a, second color 110a, third color 112a and fourth color 113a can be selected to provide a desired aesthetic appearant to cookie dough unit 100, such as by, for example, clearly illustrating and depicting the ornamental design 114.

In producing cookie dough unit 100, suitable dough formulations, and the ingredients they contain, can differ depending on the processing method and the finished product the dough formulation is to be used for. However, most cookie doughs generally have a number of ingredients in common, examples of which are described and illustrated in more detail below.

Suitable cookie doughs for use in manufacturing cookie dough unit 100 will generally contain a grain constituent that contributes to the structure of the dough. Different grain constituents lend different texture, taste and appearance to a baked good. Flour is the most commonly used grain constituent in baked goods, and in most baked foods is the primary ingredient.

Suitable flour types include hard wheat flour, soft wheat flour, corn flour, high amylose flour, low amylose flour, and the like. For example, a dough product made with a hard wheat flour will have a more coarse texture than a dough made with a soft wheat flour due to the presence of a higher amount of gluten in hard wheat flour.

Suitable cookie doughs for use in producing cookie dough unit 100 can include leavening agents that increase the volume and alter the texture of the final baked cookie. Such leavening agents can either be chemical leavening agents or yeast.

Chemical leavening typically involves the interaction of at least one leavening acid and at least one leavening base. The leavening acid generally triggers the release of carbon dioxide from the leavening base upon contact with moisture. The carbon dioxide gas aerates the dough or batter during mixing and baking to provide a light, porous cell structure, fine grain, and a texture with a desirable appearance and palatability.

Sodium bicarbonate, or baking soda, a leavening base, is the primary source of carbon dioxide gas in many chemical-leavening systems. This compound is stable and relatively inexpensive to produce. Other leavening bases include for example potassium bicarbonate, ammonium carbonate and ammonium bicarbonate.

Leavening bases can be modified in order to alter the way in which they work. For example, they can be encapsulated. Encapsulated leavening bases, such as encapsulated baking soda, will tend to delay the onset of the leavening reaction because the encapsulating material must dissolve before the leavening reaction can occur.

Generally, suitable doughs for producing cookie dough unit 100 can utilize modified or non-modified leavening bases as part of a chemical leavening system. Specifically, however, one representative embodiment of a suitable dough utilizes non-encapsulated leavening bases as part of the chemical leavening system.

Leavening acids include sodium or calcium salts of ortho, pyro, and complex phosphoric acids in which at least two active hydrogen ions are attached to the molecule. Baking acids include compounds such as monocalcium phosphate monohydrate (MCP), monocalcium phosphate anhydrous (AMCP), sodium acid pyrophosphate (SAPP), sodium aluminum phosphate (SALP), dicalcium phosphate dehydrate (DPD), dicalcium phosphate (DCP), sodium aluminum sulfate (SAS), glucono-delta-lactone (GDL), and potassium hydrogen tartrate (cream of tartar).

Suitable doughs for use in preparing cookie dough unit 100 can also contain additional ingredients. Some such additional ingredients can be used to modify the texture of dough. Texture modifying agents can improve many properties of the dough, such as viscoelastic properties, plasticity, or dough development. Examples of texture modifying agents include fats, emulsifiers, hydrocolloids, and the like.

Emulsifiers include nonionic, anionic, and/or cationic surfactants that can be used to influence the texture and homogeneity of a dough mixture, increase dough stability, improve eating quality, and prolong palatability. Emulsifiers include compounds such as lecithin, mono- and diglycerides of fatty acids, propylene glycol mono- and diesters of fatty acids, glyceryl-lacto esters of fatty acids, and ethoxylated mono- and diglycerides.

Hydrocolloids are added to dough formulations to increase moisture content, and to improve viscoelastic properties of the dough and the crumb texture of the final product. Hydrocolloids function both by stabilizing small air cells within the batter and by binding to moisture within the dough. Hydrocolloids include compounds such as xanthan gum, guar gum, and locust bean gum.

Dough can also include flavorings such as sweeteners, spices, and specific flavorings such as bread, vanilla or butter flavoring. Sweeteners include regular and high fructose corn syrup, sucrose (cane or beet sugar), and dextrose, for example. In addition to flavoring the baked good, sweeteners such as sugar can increase the moisture retention of a baked good, thereby increasing its tenderness.

Dough can also include preservatives and mold inhibitors such as sodium salts of propionic or sorbic acids, sodium diacetate, vinegar, monocalcium phosphate, lactic acid and mixtures thereof.

Another ingredient in formulating suitable cookie doughs for the high speed production of cookie dough unit 100 is shortening. Shortening helps to improve the volume, grain and texture of the final product. Shortening also has a tenderizing effect and improves overall palatability and flavor of a baked good. Natural shortenings, animal or vegetable, or synthetic shortenings can be used. Generally, shortening is comprised of triglycerides, fats and fatty oils made predominantly of triesters of glycerol with fatty acids. Fats and fatty oils useful in producing shortening include cotton seed oil, ground nut oil, soybean oil, sunflower oil, rapeseed oil, sesame oil, olive oil, corn oil, safflower oil, palm oil, palm kernel oil, coconut oil, or combinations thereof. As will be discussed in further detail below, selecting a shortening with a desirable SFI or Solid Fat Index provides for a cookie dough that is neither too sticky or too deformable for use in extruding cookie dough unit 100.

Another dough ingredient for the formulation of cookie doughs suitable for use in the production of cookie dough unit 100 is sugar. By varying the amount of sugar within the cookie dough, dough processing characteristics such as stickiness can be controlled. In addition, sugar is one of the primary ingredients affecting taste, texture and appearance of a final baked cookie. In addition to sugar amounts, sugar characteristics such as particle size distribution can be specified so as to achieve optimal processing and baking performance such as, for example, shape retention, spread and overall surface texture. For example, sugar can be specifically ground so as to achieve a desired sugar particle size distribution. For instance, it has been found that using sugar having a desired particle size distribution is one method by which bake induced expansion can be increased for cookie dough unit 100 as compared to using a standard, unspecified sugar grind.

It has been determined that sugar ground so as to have a particle size distribution wherein between about 18% and about 45% by weight of the sugar is retained by a conventional 100 mesh screen provides a suitable sugar that increases bake induced expansion. It has been further discovered that a more preferred sugar composition can comprise a composition wherein between about 18% and about 45% by weight of the sugar is retained by a conventional 100 mesh screen and less than about 3.5% by weight of the sugar is retained by a conventional 50 mesh screen. These sugar compositions can be achieved by sifting commercially available bulk sugar with a batch sifter such as, for example, a Ro-Tap or equivalent sifter, wherein a 50 mesh screen is placed at the top and a 100 mesh screen is placed below the 50 mesh screen. Once the bulk sugar has been sifted, the portions can be recombined by weight to achieve the aforementioned particle size distributions for the sugar used within the dough formulation. In commercial practice, the desired sugar particle size distributions can be ground in a manner to achieve suitable particle size distributions without requiring subsequent sifting.

In general, a variety of suitable dough formulations are contemplated for the invention. For example, it has been found that cookie doughs can be formulated within the following composition ranges that are suitable for forming cookie dough units and achieving desirable baked cookie units. Suitable dough formulations can comprise:

| Ingredient | Weight Percent Range |
|---|---|
| Sugar | 20-35 |
| Shortening | 20-30 |
| Flour | 30-40 |
| Enrich | 0.1-0.3 |
| Water | 4-15 |
| Salt | 0.0-1.0 |
| Vanilla | 0.0-1.0 |
| Color | 0.1-1.0 |
| Egg Solids | 0.2-2.0 |
| Alb. | 0.1-1.0 |
| Soda | 0.1-0.6 |
| SALP | 0.1-0.6 |

Within the aforementioned composition ranges, a variety of specific formulations are contemplated. The invention is now illustrated in greater detail by way of the following specific examples, but it should be understood that the invention is not to be construed as being limited thereto.

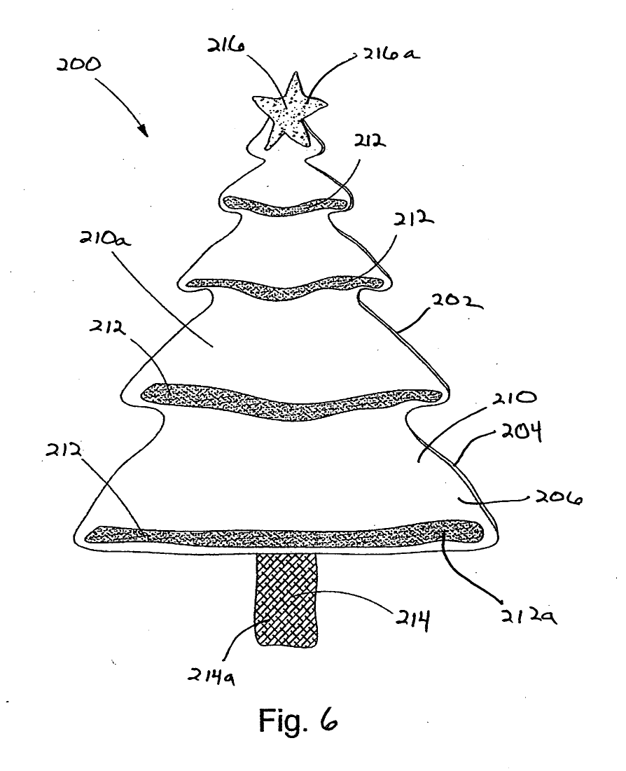

Once each dough is formed, each individual dough can be placed within a dough hopper such as, for example, a supply hopper to a pumping system. For example, referring now to FIG. 4, a process is depicted where in the case of first dough 108, second dough 110, third dough 112 and fourth dough 113, the doughs can be placed in a corresponding first dough hopper 122a, second dough hopper 122b, third dough hopper 122c and fourth dough hopper 122d. FIG. 4 provides a schematic representation of an extrusion process 123 for continuously producing cookie dough units 100 at suitable production speeds. Cookie dough is pumped from each of the hoppers 122a, 122b, 122c, 122d using a pump 124 into an extruder 126. Pump 124 and extruder 126 can comprise suitable pumps and extruders for use with high viscosity compositions such as cookie dough. Suitable pumps 124 and extruders 126 are commercially available from suppliers such as Bepex GmBh of Leingarten, Germany, Robert Reiser & Co. of Canton, Mass. and Albert Handtmann Holding Gmbh & Co. KG of Biberbach, Germany. Within the extruder 126, the individual dough streams are simultaneously extruded through a form as described in previously referenced and commonly assigned U.S. Pat. No. 5,620,713 to Rasmussen, which is herein incorporated by reference to the extent not inconsistent with the present disclosure. Within extruder 64, the multiple dough streams are combined into a continuous tube or dough rope 128. Dough rope 128 is then cooled by a precooler 130. Dough rope 128 can be extruded to have a diameter from about 0.4″ to about 4.0′, or a diameter within a range of about 0.75″ to about 3.0″, and alternatively, within a range of about 1.1″ to about 2.0″.

Prior to extrusion, each dough is formulated and prepared such that the dough is not too deformable which can result in the formation of an unacceptable cookie dough unit 100. The dough should be formulated and mixed to have sufficient structure for processing including conveying and further handling as described below. For example, shortening selection can be important to impart desirable extrusion properties to the cookie dough. Suitable shortenings for use in extrudable cookie doughs of the invention have a SFI (Solid Fat Index) of between about 22 to about 35 at about 70° F., or between about 24 to about 32 at 70° F., and alternatively about 25 at 70° F., as defined by American Oil Chemists' Society Method Cd 10-57. If shortening is used with a SFI below about 22 at 70° F., the viscosity of the cookie dough can decrease to a point where the dough is too soft either to extrude or make it difficult to extrude a structurally or graphically stable cookie dough unit 100 or one that is suitable for further processing. In addition, first dough portion 108, second dough portion 110, and possibly third dough portion 112 and fourth dough portion 113 can deform or smear such that ornamental design 114 may be unrecognizable.

During extrusion, the cookie dough can be maintained within a temperature range of about 40° F. to about 70° F., or within a range of about 53° F. to about 68° F. Within these temperature ranges, the cookie dough can be pumped using optional pump 124 and extruded using extruder 126. Below these processing ranges, the shortening within the cookie dough can be too firm, making it difficult to pump and extrude and furthermore, can result in the shortening failing to cream, resulting in the presence of shortening pockets within the cookie dough unit 100.

Following extrusion, a dough rope surface 129 on dough rope 128 is cooled within the precooler 130. Precooler 130 can be configured to cool using a variety of cooling mediums such as, for example, by an air blast, holding the dough in a refrigerated or freezing chamber, or by other suitable means. Regardless of cooling medium, precooler 130 preferably operates below about 32° F. to cool dough rope surface 129 to a temperature suitable for a high speed cutting operation, said cooling preferably being accomplished within the precooler in about 10 seconds to about 120 seconds, and most preferably in about 20 seconds to about 60 seconds. While described and depicted as part of the process of forming cookie dough unit 100, it is to be understood that the use of precooler 130, and the subsequent cooling of the dough rope 128, may be unnecessary depending upon the temperature and more specifically, the viscosity of the dough rope 128 as it exits the extruder 126.

Next, the dough rope 128, regardless of whether the dough rope surface 129 has been cooled within precooler 130, is directed to a cutting station 132 wherein the dough rope 128 is sliced to form the individual cookie dough units 100. Cutting station 132 can employ a wide variety of suitable and appropriate cutting instruments such as, for example, mechanical or reciprocating wires, knifes, blades and saws. In one arrangement, cutting station 132 can employ an appropriately sized and powered ultrasonic cutter that has increased ability to avoid smearing of the various dough portions. For example, first dough portion 108, second dough portion 110 and third dough portion 112, within the cookie dough unit 100 can be cut using an ultrasonic cutter without smearing such dough portions yet avoid overall deformation of the cookie dough unit 100. Dough rope variables such as, for example, temperature, moisture, texture and viscosity as well as the cutting blade design employed for cutting station 132 can affect the speed at which cookie dough units 100 can be cut from dough rope 128. Cookie dough units 100 can be cut such that unit thickness 116 ranges from about 0.2″ to about 1.5″ and alternatively from about 0.5″ to about 1.5″.

From the cutting station 132, the individually separated and distinguishable cookie dough units 100 can be transferred from the cutting station 132 through suitable material handling equipments such as, for example, a conveyor system. A representative conveyor system can be of the type disclosed in commonly assigned U.S. Pat. Nos. 6,561,235 and 6,715,518 to Rasmussen et al., each of which is herein incorporated by reference to the extent not inconsistent with the present disclosure. Using a conveyor system, individual cookie dough units 100 can be carried through a tunnel freezer 134 where the cookie dough units 100 are cooled and frozen. As both first side 104 and second side 106 are exposed within the tunnel freezer 134, cooling of the cookie dough units 100 dough generally occurs more quickly than when the cookie dough is present in the form of dough rope 128. Following a freezing operation, cookie dough units 100 can be packaged, for example on tray 136, for shipment, display and storage.

During display at a retail outlet or in storage following purchase by a consumer, cookie dough units 100 are maintained in a refrigerated state. At time of consumption, cookie dough units 100 are baked with a thermal process to form a baked cookie unit. A baked cookie unit generally resembles cookie dough unit 100 as the baked cookie unit has a generally round shape with the ornamental design visible on both the first side and the second side. Generally speaking, the significant appearance difference between the baked cookie unit and the cookie dough unit 100 is that baking causes significant expansion of the cookie dough unit 100 such that the area of baked cookie unit is at least two times the area of the cookie dough unit 100. During this expansion, ornamental design 114 remains consistent and distinguishable as all of the doughs used in forming the cookie dough unit 100, for example first dough portion 108, second dough portion 110, third dough portion 112 and fourth dough portion 113, can have substantially the same formulation, with the exception of color and slight moisture variations, such that all of the various doughs experience the same amount of expansion during baking.

As used through the present disclosure, percentages and ratios are calculated by weight unless otherwise indicated. In addition, all percentages and ratios, based on weight or otherwise, are calculated based on the total composition unless otherwise stated.

### PREPATORY EXAMPLE 1

One representative formulation for preparing first dough portion 108, second dough portion 110, third dough portion 112 and fourth dough portion 113 for use in preparing cookie dough unit 100 as described previously is as follows:

| Ingredient | Weight Percent |
|---|---|
| Sugar | 30.9 |
| Shortening | 24.6 |
| Flour | 34.3 |
| Enrich | 0.1 |
| Water | 7.0 |
| Salt | 0.5 |
| Vanilla | 0.3 |
| Color | 0.2 |
| Egg Solids | 1.0 |
| Alb. | 0.5 |
| Soda | 0.3 |
| SALP | 0.3 |
| Total | 100 |

In preparing the cookie dough unit 100 of the invention, individual dough batches were created to produce first dough portion 108, second dough portion 110, third dough portion 112 and fourth dough portion 113 when desired. To prepare a dough, the shortening, selected to have a suitable SFI as previously discussed, was added to a mixer (e.g., a paddle or equivalent mixer).

The shortening can be added at a temperature of about 65 to about 80° F., and more preferably at a temperature of about 68 to about 75° F. If the shortening is too cold, the shortening may fail to properly cream during the mixing process such that unblended shortening portions can be present in the final dough.

The sugar, comprising the previously disclosed particle size distribution, was added to the mixer at ambient temperature. The sugar and shortening mixture was creamed within the mixer for approximately one minute at 80 rpm. The mixer and mixing blades were then scraped and the creaming continues for approximately another four minutes at 80 rpm. Following creaming, the slurry (water, salt, vanilla, and color (if required)) was added to the sugar and shortening mixture. The slurry ingredients were blended prior to their addition and held at a temperature of about 25° F. to about 50° F. This holding temperature can also be conducted at about 30° F. to about 40° F. The slurry was added to the mixer and blended with the sugar and shortening for approximately one minute at 40 rpm. The flour was then added to the mixer at a temperature of about 0° F. to about 50° F. This step can alternatively be conducted at a temperature of about 5° F. to about 30° F. The minor dry ingredients (egg yolk solids, albumin, soda, SALP and enrichment) were dry blended and added to the flour. The dry ingredients were held at ambient temperatures until use. The flour and dry minor ingredients were then mixed with the shortening, sugar, and slurry for approximately one minute at 40 rpm wherein mixing of the dough is completed. The dough was then removed from the mixer. The dough temperature out of the mixer is generally about 45° F. to about 65° F., but may be at about 50° F. to about 60° F. The dough was held for about 30 minutes prior to further processing. When mixed, the dough was determined to have a density ranging from about 0.8 to about 1.2; although certain doughs may be a density of about 1 to about 1.1. In addition, the pH of the dough can be about 6.5 to about 7.2, or near the pH of the large portion of the ingredients (flour, sugar).

### PREPATORY EXAMPLE 2

An alternative, representative formulation for preparing first dough portion 108, second dough portion 110, third dough portion 112 and fourth dough portion 113 for use in preparing cookie dough unit 100 as described previously is as follows:

| Ingredient | Weight Percent |
|---|---|
| Sugar | 34.5 |
| Shortening | 23.0 |
| Flour | 32.5 |
| Enrich | 0.2 |
| Water | 7.5 |
| Salt | 0.4 |
| Vanilla | 0.3 |
| Color | 0.5 |
| Egg Solids | 0.8 |
| Alb. | 0.7 |
| Soda | 0.3 |
| SALP | 0.3 |
| Total | 100 |

The formulation disclosed in Example 2 is similarly mixed and prepared as described above with reference to Prepatory Example 1.

### PREPATORY EXAMPLE 3

Doughs made in Prepatory Examples 1 and 2 were processed using a process as described herein. Coextrusion of the doughs (i.e. first, second, third and/or fourth) was accomplished under the conditions set forth in this disclosure, to produce a rope of cookie dough. By subsequent ultrasonic cutting operation, cookie dough units were cut from the dough rope. These cookie units were found to have maintained the intended image, where no smudging or smearing occurred between or within dough and dough colors. The design was graphically stable.

Using the aforementioned dough formulations, cookie dough unit 100 is capable of bake-induced expansion at a percentage significantly higher than experienced with previous extruded cookies such as, for example, the cookies disclosed in previously mentioned and commonly assigned U.S. Pat. No. 5,620,713, to Rasmussen.

It will thus be seen according to the invention a highly advantageous cookie dough unit having an integral, preformed extruded design has been provided. While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

1. A ready-to-bake extruded cookie unit comprising:
a first cookie dough having a first color; and
a second cookie dough having a second color;
wherein both the first cookie dough and the second cookie dough comprise a shortening with a Solid Fat Index between about 22 to about 35 at about 70° F., and
wherein the first cookie dough and the second cookie dough are coextruded so as to cooperatively define a continuous design element between a top surface and a bottom surface of the ready-to-bake extruded cookie unit.

2. The ready-to-bake extruded cookie unit of claim 1 wherein the first cookie dough defines a perimeter surface.

3. The ready-to-bake extruded cookie unit of claim 2 wherein the second cookie dough is bounded by the perimeter surface of said first cookie dough.

4. The ready-to-bake extruded cookie unit of claim 1, wherein the first cookie dough and the second cookie dough further define a unit height and a widest cross-sectional length and wherein a ratio of unit height to the widest cross-sectional length is within a range of about 0.12 to about 3.0.

5. The ready-to-bake extruded cookie unit of claim 4, wherein the ratio of unit height to the widest cross-sectional length is within a range of about 0.3 to about 0.5.

6. The ready-to-bake extruded cookie unit of claim 4, wherein the first cookie dough and the second cookie dough define a generally round shape such that the widest cross-section length comprises a diameter of the generally round shape.

7. The ready-to-bake extruded cookie unit of claim 1, wherein the first cookie dough comprises from about 40% to about 90% by weight of the ready-to-bake cookie unit.

8. The ready-to-bake cookie unit of claim 1, further comprising at least a third cookie dough having a third color accenting the continuous design element, the third cookie dough being coextruded with the first cookie dough and the second cookie dough.

9. The ready-to-bake cookie unit of claim 1, wherein the continuous design element comprises at least one of a holiday symbol, an athletic symbol, a religious symbol, an educational symbol, a patriotic symbol, a corporate symbol and a textual message.

10. The ready-to-bake cookie unit of claim 1, wherein the first cookie dough and the second cookie dough comprise sugar having a sugar particle size distribution, the particle size distribution defined as being between about 18% by weight and about 45% by weight of the sugar retained by a 100 mesh screen.

11. The ready-to-bake cookie unit of claim 12, wherein the sugar particle size distribution further comprises less than about 3.5% by weight of the sugar retained by a 50 mesh screen.

12. The ready-to-bake cookie unit of claim 1 wherein the shortening has a Solid Fat Index between about 24 to about 32 at about 70° F.

13. The ready-to-bake cookie unit of claim 1, further comprising a flavored inclusion selected from the group consisting of a fruit, a nut, a candy, a spice, a flavorant and combinations thereof.

14. A method for forming an extruded ready-to-bake cookie unit comprising the steps of:
providing shortening having a Solid Fat Index between about 22 to about 35 at about 70° F.;
combining the shortening with sugar, water and flour to form a first cookie dough and a second cookie dough;
extruding the first cookie dough and the second cookie dough simultaneously so as to form a continuous dough rope; and
cutting the continuous dough rope so as to form the ready-to-bake-cookie unit, the ready-to-bake cookie unit having a continuous design element extending from a top surface to a bottom surface of the ready-to-bake cookie unit, the continuous design element defined by the first cookie dough and the second cookie dough.

15. The method of claim 14, further comprising:
positioning the ready-to-bake cookie unit on a packaging tray.

16. The method of claim 14, wherein cutting the dough rope comprises slicing the dough rope with a cutting member, the cutting member comprising at least one of an ultrasonic cutter and a wire cutter.

17. The method of claim 14, further comprising:
grinding the sugar such that the sugar has a particle size distribution defined as being between about 18% by weight and about 45% by weight of the sugar retained by a 100 mesh screen.

18. The method of claim 17, wherein grinding the sugar results in the particle size distribution comprising less than about 3.5% by weight of the sugar retained by a 50 mesh screen.

19. An extruded cookie dough unit made from the process according to claim 14.

20. A packaged dough product comprising:
a plurality of coextruded cookie units, each coextruded cookie unit having a first cookie dough with a first color and a second cookie dough with a second color, the first cookie dough and the second cookie dough both comprising a shortening with a Solid Fat Index between about 22 to about 35 at about 70° F. and wherein the first cookie dough and the second cookie dough cooperatively define a continuous design element between a top surface and a bottom surface of each coextruded cookie units; and
a packaging container for shipping and storing the plurality of coextruded cookie units.

21. A ready-to-bake extruded cookie unit comprising:
a first cookie dough having a first color; and
a second cookie dough having a second color;
wherein both the first cookie dough and the second cookie dough comprise a shortening with a Solid Fat Index between about 22 to about 35 at about 70° F.,
wherein the first cookie dough and the second cookie dough are coextruded so as to cooperatively define a continuous design element between a top surface and a bottom surface of the ready-to-bake extruded cookie unit, and
wherein the first cookie dough defines a perimeter surface defining an ornamental shape of the ready-to-bake extruded cookie unit.

22. An extruded, generally non-circular cookie dough unit having an integral design element, comprising;
a dough unit, having first and second sides;
an integral design element;
said dough intermediate having at least first and second portions;
wherein said at least first and second portions of said dough unit combine together to form a dough unit having a shaped external configuration other than generally circular and said integral design element that is visible on each of said first and second sides.
